(19) United States
(12) Patent Application Publication
(10) Pub. No.: US 2006/0040661 A1
(43) Pub. Date: Feb. 23, 2006

(54) Method for operating terminals of a mobile radio communication system

(76) Inventors: Hyung-Nam Choi, Hamburg (DE); Michael Eckert, Braunschweig (DE); Achim Luft, Braunschweig (DE)

Correspondence Address: BELL, BOYD & LLOYD, LLC, P. O. BOX 1135, CHICAGO, IL, 60690-1135, US

(21) Appl. No.: 10/535,492

(22) PCT Filed: Nov. 21, 2003
(86) PCT No.: PCT/EP03/13093

§ 371 Date: May 17, 2005

(30) Foreign Application Priority Data
Feb. 25, 2003 (DE) 10308012.0

(51) Int. Cl. H04Q 7/20

(52) U.S. Cl. 455/432.3

(57) ABSTRACT

A system and method is disclosed for operating terminals of a mobile radio communication system operating preferably under an UMTS standard in at least one wireless local area network (WLAN). At least one piece of access data can be stored on the terminal, with the access data being encoded in such a way that the access data comprises at least one first piece of identifying data for the mobile radio communication system and at least one second piece of identifying data for the local area network.

### FIELD OF TECHNOLOGY

The invention relates to a method for operating terminals of a mobile radio communication system.

### BACKGROUND

Information and communication networks are converging to an increasing degree. For this reason, efforts are also being made to design radio communication systems of the so-called “third generation” (3G), such as UMTS (Universal Mobile Telecommunications System) and other systems in such a way as to enable as uncomplicated a connection as possible to data networks also.

Thus, the connection of WLAN (Wireless Local Area Network) in UMTS is a subject of discussion in, for example, the 3GPP standardization committees. There is great interest in a connection of this kind on account of the technical possibilities of WLAN, for example in order to use in part public, free WLAN access points, referred to as “hot spots”, as an add-on to UMTS in small, local areas with a high subscriber density such as airports, hotels, etc.

In this context consideration is being given to various WLAN technologies which enable broadband radio access to the broadband data networks based on TCP/IP, ATM or B-ISDN. Examples of broadband WLAN technologies are IEEE 802.11a, IEEE 802.11b, Hiperlan/2, OpenAir or SWAP. However, a restriction to a specific WLAN technology is not established, so the designation WLAN is used in the following description for simplicity.

The basic principle of WLAN is shown in FIG. 1. WLAN can be used to build a wireless local communication network in which mobile terminals MT are connected by means of radio via what are known as access points AP (WLAN base stations) to the broadband data networks BDN. Each access point AP serves all the mobile terminals MT located in a cell, whereby the maximum cell size can extend up to several hundred meters. WLAN can be used to build a cellular radio network in which an existing data connection can be handed off from access point to access point in line with the movement of the mobile terminals MT (roaming). The maximum data rates are dependent on the respective WLAN technology and can reach up to 54 Mbit/s, for example.

Various possible solutions for the connection of WLAN in UMTS are under discussion in the 3GPP standardization committees. One proposal in this context is a rather “loose” connection in which the WLAN and UMTS represent autonomous systems which are linked to each other by way of what is referred to as an “interworking unit” IWU. A possible network architecture for this is illustrated by way of example in FIG. 2. In this case, the WLAN network architecture is represented with the elements AP, router and AAAL, while the UMTS network architecture is shown with the elements UMTS base station NodeB, RNC, SGSN, GGSN and HSS. The task of the interworking unit IWU is to convert signaling and user data from WLAN to UMTS and vice versa. The solution on the basis of an IWU connection is very advantageous because by this means there is no need to implement major changes in the network and protocol architecture of the WLAN and more particularly of UMTS. In the UMTS terminal, the WLAN connection can be implemented by means of an appropriate module in the form either of a WLAN radio section that is already integrated in addition into the UMTS terminal or as a WLAN PC card which has to be inserted into the corresponding interface of the terminal, for example in the form of a PCMCIA interface.

Because of the application of WLAN in hot spots it is assumed that in the future there will be a plurality of public as well as private WLAN providers worldwide, with each also operating their respective networks with different WLAN technologies. A problem for UMTS terminals using WLAN is the requirement to have a WLAN module with the appropriate technology for the respective WLAN access. An additional problem is that the respective UMTS terminal must also register as a customer with the respective network provider, either on the basis of a contract or dynamically at the present location.

In existing WLAN networks it is usually sufficient to specify only name, password and IP address for user authentication purposes. Furthermore, WLAN networks are currently identified and authenticated only by means of an arbitrarily chosen name (e.g. “WLAN Hamburg Airport”) and the IP address of the access point.

A network architecture which enables mobile subscribers of a GSM network to use a wireless LAN network on the basis of identification information contained on a SIM card is known from Ala-Laurila J. et al, Wireless LAN Access Network Architecture for Mobile Operators, IEEE Communications Magazine, November 2001, Vol. 39, pages 82 to 89.

### BRIEF SUMMARY

Under an exemplary embodiment, a method is disclosed which permits a mobile radio terminal to be operated in a more heterogeneous environment than that described above.

A system and method is disclosed for operating in accordance with the UMTS standard, in at least one mobile radio device wireless local area network, for example a network operating in accordance with an IEEE 802.11 standard. Under the embodiment, at least one item of access information can be stored on the terminal, wherein the access information is encoded in such a way that it comprises at least one first item of identification information for the mobile radio communication system and at least one second item of identification information for the local area network.

As a result of storing the at least one item of access information which includes both identification information for a mobile radio communication system and identification information for a local area network, a particularly simple and effective method of handling an access to telecommunication and information networks is created. The storing of said information on the terminals to be operated in such networks gives the providers control over the granting of such accesses, since a range of services is agreed, for example upon conclusion of a usage contract, and can be taken into account by appropriate storage of access information when the corresponding terminal is issued.

The second item of identification information preferably comprises a first item of information indicating the location of the local area network so that it can be determined in the terminal whether it is possible to use or, as the case may be, register with a local area network at the current location of the terminal.

Advantageously the second item of identification information includes a second item of information indicating the type of the local area network so that, for example, necessary parameter settings can be made on the part of the terminal or the terminal can deduce information about the services provided by the network.

The latter can be determined by the terminal with less-overhead if the method is implemented in such a way that the second item of identification information comprises a third item of information about at least one service provided by the local area network.

Whereas information relating to location, type and services provided is adequate, primarily for the identification of and access to public local area networks, a fourth item of information by means of which the local area network is uniquely identifiable, said information being included as part of the second item of identification information, permits the dedicated selection of networks, which selection is necessary in particular when a restriction of the access to the respective local area networks has been imposed either on the part of the provider of the mobile radio system or on the part of operators of local area networks.

Preferably the first, second and/or third items of information are encoded by means of a maximum of three decimal digits and the fourth item of information is encoded by means of a maximum of five decimal digits, so that a maximum of seven bytes are necessary for encoding the second item of identification information.

If the second items of identification information are stored as a first list organized in such a way that the first list contains those second items of identification information that are assigned to local area networks which allow the operation of the terminal within the local area network, then a suitable, currently reachable local area network that is accessible to the terminal can be identified in a simple manner on the basis of the data records stored in the table.

Alternatively, the second items of identification information can be stored as a first list organized in such a way that the first list contains those second items of identification information that are assigned to local area networks which forbid the operation of the terminal within the local area network. This can be advantageously applied for example when terminals of the mobile communication system are embodied in such a way that they display to the user local area networks currently located in the radio coverage area of the terminal, determined either independently or through evaluation of signaling sequences, with networks that cannot be filtered out.

The at least first item of access information is preferably stored on a device serving for user identification, in particular a USIM module. Under this configuration, terminals are spared from changes necessary for the implementation of the method disclosed herein. In addition it offers the advantage that in the event of a change of terminal, a common practice in mobile radio communication systems, the access information is preserved.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates an exemplary WLAN network known in the art;

FIG. 2 illustrates a network architecture for a connection of a wireless local area network (WLAN) to a UMTS mobile radio communication system, under the prior art;

FIG. 3 illustrates elements of user equipment of a WLAN network, under an exemplary embodiment;

FIG. 4 illustrates a table listing usable WLAN networks under the embodiment of FIG. 3; and

FIG. 5 illustrates a table listing non-usable WLAN networks.

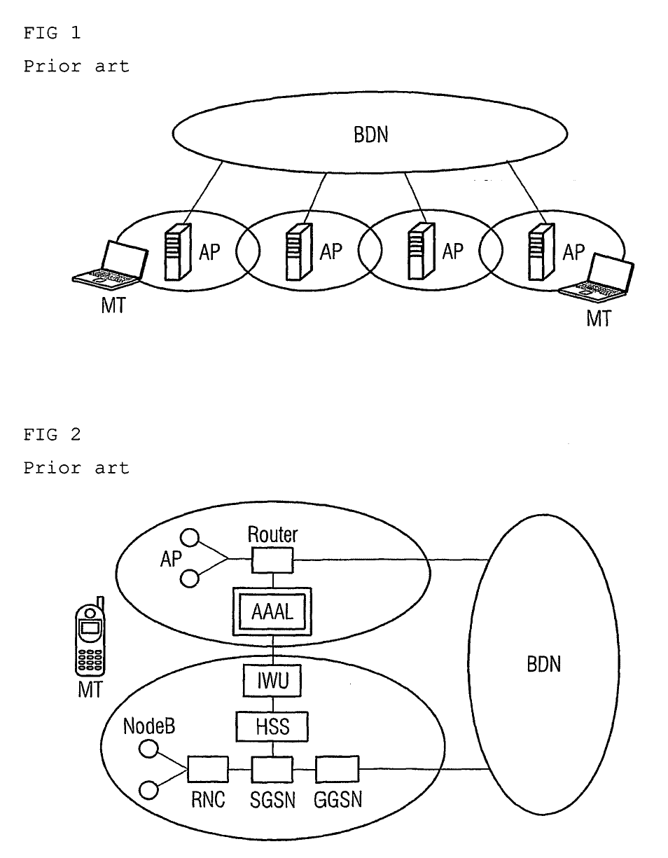

### DETAILED DESCRIPTION

An exemplary embodiment of the invention is given by an implementation of the method executed in a heterogeneous environment consisting of a mobile radio communication system operated in accordance with the UMTS standard as well as at least one local wireless network (WLAN) operated in accordance with the IEEE 802.11 standard. For this reason essential details of said systems are described below to aid in the understanding of the invention and the following abbreviations are introduced in the interests of maintaining an overview:

| | |
|---|---|
| 3GPP | Third Generation Partnership Project |
| AAAL | Authentication Authorization Accounting Local |
| AP | Access Point |
| ATM | Asynchronous Transfer Modus |
| AWPLMN | Allowed WLAN PLMN |
| BDN | Broadband Data Networks |
| B-ISDN | Broadband Integrated Services Digital Network |
| EF | Elementary File |
| FPLMN | Forbidden PLMN |
| FWPLMN | Forbidden WLAN PLMN |
| GGSN | Gateway GPRS Support Node |
| GPRS | General Packet Radio Service |
| Hiperlan/2 | High Performance Local Area Network Type 2 |
| HPLMNwAcT | Home PLMN selector with Access Technology |
| HSS | Home Subscriber Server |
| IEEE | Institute of Electrical and Electronics Engineers |
| IMSI | International Mobile Subscriber Identity |
| IP | Internet Protocol |
| IWU | Interworking Unit |
| Mbit/s | Mega bits per second |
| MCC | Mobile Country Code |
| ME | Mobile Equipment |
| MNC | Mobile Network Code |
| MT | Mobile terminal |
| OPLMNwAcT | Operator controlled PLMN selector with Access |
| | Technology |
| PCMCIA | Personal Computer Memory Card International |
| | Association |
| PLMN | Public Land Mobile Network |
| PLMNwAcT | User controlled PLMN selector with Access Technology |
| RNC | Radio-Network Controller |
| SGSN | Serving GPRS Support Node |
| SWAP | Shared Wireless Access Protocol |
| TCP | Transmission Control Protocol |
| UE | User Equipment |
| UICC | Universal Integrated Circuit Card |
| UMTS | Universal Mobile Telecommunications System |
| USAT | USIM Application Toolkit |
| USIM | Universal Subscriber Identity Module |
| WAC | WLAN Application Code |
| WLAN | Wireless Local Area Network |
| WNC | WLAN Network Code |
| WTC | WLAN Type Code |

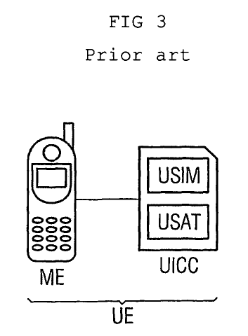

In UMTS the actual terminal, referred to there as UE (User Equipment), consists of ME (Mobile Equipment) and the physical chipcard UICC shown in FIG. 3. The USIM (Universal Subscriber Identity Module) is implemented as standard on the UICC, together with the USAT functionality (USIM Application Toolkit). The USIM is needed in order for a mobile radio subscriber to be able to use his/her ME in a UMTS radio network. All the subscriber access data serving to identify and verify the access authorization (authentication) of the mobile radio subscriber as well as to guarantee the encryption and decryption of the user data in order to protect against eavesdropping and manipulation is preferably stored on the USIM. In practice, the data is stored on the USIM in the form of “elementary files” (EF); see 3GPP TS 31.102: Characteristics of the USIM Application. For example, the IMSI (International Mobile Subscriber Identity) is stored in the file EF_IMSI and the keys for encrypting and decrypting the user data in the file EF_Keys.

Also stored on the USIM under the exemplary embodiment are corresponding lists of von PLMNs (Public Land Mobile Network), i.e. public mobile radio networks, on the basis of which a mobile radio subscriber can register in a mobile radio network on the basis of his/her actual location:
EF_HPLMNwAcT (Home PLMN selector with Access Technology):
This list contains the identities assigned to a mobile radio subscriber in his/her home mobile radio network (Home PLMN) complete with specification of the radio transmission technology.
EF_PLMNwAcT (User controlled PLMN selector with Access Technology): This list contains the identities of mobile radio networks controlled by the mobile radio subscriber complete with specification of the respective radio transmission technology.
EF_OPLMNwAcT (Operator controlled PLMN selector with Access Technology): This list contains the identities of mobile radio networks controlled by the network operator complete with specification of the respective radio transmission technology.
EF_FPLMN (Forbidden PLENS): This list contains the identities of barred mobile radio networks in which a mobile radio subscriber is not allowed to register.

In the aforementioned lists the respective PLMNs are identified by means of unique PLMN identities. The PLMN identities are composed here of the following two components:
The Mobile Country Code (MCC) consists of three digits (decimal). The MCC uniquely identifies the country in which the mobile radio network is operated. For example, the code for Germany is MCC=“262” and the code for the United Kingdom is MCC=“234”.
The Mobile Network Code (MNC) consists of three digits (decimal) and uniquely identifies the mobile radio network on the basis of the MCC. For example, the following codes are defined for Germany: MNC=001 for T-Mobile, MNC=002 for Vodafone, MNC=003 for E-Plus and MNC=007 for Viag.

Accordingly, a method may be implemented under the embodiment for encoding WLAN identities for the identification and authentication of WLAN networks as well as the WLAN access of UMTS users on the basis of WLAN identity lists that are stored on the USIM. It is assumed as a precondition here that the UMTS terminal also has a WLAN module of the respective technology. A USIM-based solution offers the following advantages:
WLAN networks can be identified and authenticated in an certain manner.
Access by UMTS subscribers in WLAN networks is realized in an uncomplicated manner.
UMTS and WLAN providers can control the WLAN access for specific networks or, as the case may be, classes of networks.

To enable the identification and authentication of WLAN networks, the networks are encoded under the embodiment by means of an identity which is composed of the following four components:
WLAN identity=MCC+WTC+WAC+WNC, where
the Mobile Country Code (MCC) comprises three digits (decimal) and uniquely identifies the country in which the WLAN network is operated,
the WLAN Type Code (WTC) comprises a maximum of three digits (decimal) and uniquely identifies the type of the WLAN network,
the WLAN Application Code (WAC) comprises a maximum of three digits (decimal) and uniquely identifies the WLAN application,
the WLAN Network Code (WNC) comprises a maximum of five digits (decimal) and uniquely identifies the WLAN network on the basis of the MCC, WTC and WAC.

The length of a WLAN identity comprises a maximum of fourteen digits (decimal). Other combinations are possible for the definition of WTC and WAC. For example, the following could be defined as WLAN Type Codes:
“001”=Public, Type 1
“002”=Public, Type 2
“003”=Private, Type 1
“004”=Private, Type 2
etc.

Similarly, the following could be defined as WLAN Application Codes:
“001”=Airport
“002”=Hotel, Luxury Category
“003”=Hotel, Midrange Category
“004”=Station
“005”=Coffee Shop
etc.

Alternatively, the WLAN access is determined on the basis of WLAN identity lists. For this purpose the files EF_AWPLMN (Allowed WLAN PLMNs) and EF_FWPLMN (Forbidden WLAN PLMNs) are defined on the USIM. The file EF_AWPLMN contains in the form of a list the identities of the WLAN networks permitted for a UMTS subscriber and has a length of n*7 bytes as standard. Similarly, the file EF_FWPLMN contains in the form of a list the identities of the WLAN networks prohibited for a UMTS subscriber and has a length of n*7 bytes as standard. The parameter n specifies the number of WLAN networks contained in the list. Seven bytes are allocated for the identity per listed WLAN network. The seven bytes result from the fact that each individual digit of the WLAN identity is coded using four bits in each case. Table 1 shows an example of the structure of the file EF_AWPLMN or, as the case may be, EF_FWPLMN.

TABLE 1
Structure of the file EF_AWPLMN or
EF_FWPLMN

| Bytes | Description | Length |
|---|---|---|
| 1 to 7 | 1st WLAN PLMN | 7 bytes |
| 8 to 14 | 2nd WLAN PLMN | 7 bytes |
| . . . | . . . | . . . |
| (7*n − 6) to (7*n) | Nth WLAN PLMN | 7 bytes |

These WLAN identity lists enable a UMTS user, upon signing a contract with his/her UMTS or WLAN provider, to be allowed or barred from corresponding WLAN accesses depending on whether he/she wishes also to use WLAN in addition to UMTS. The WLAN identity lists further permit the dynamic handling of the allowed or, as the case may be, barred WLANs also during the term of the contract.

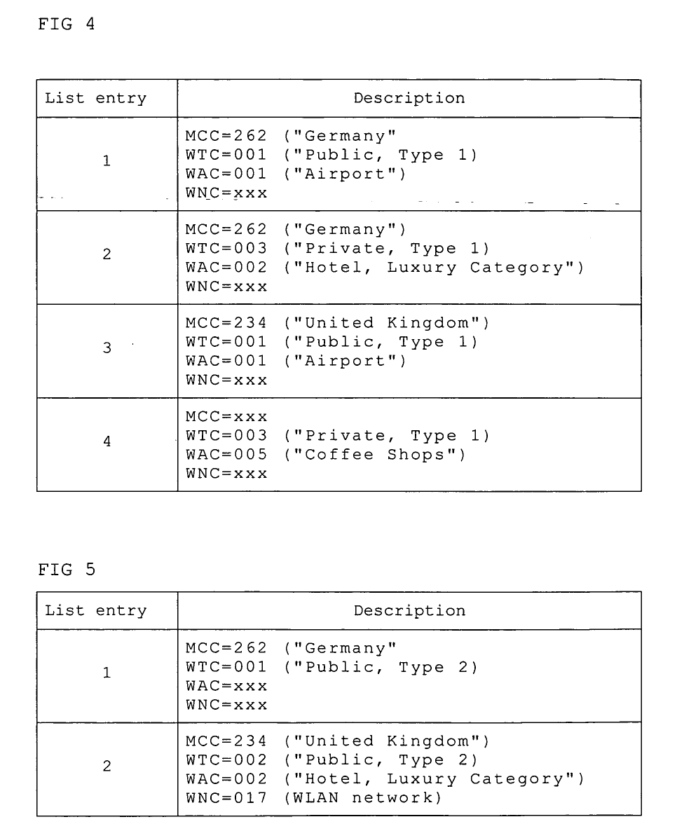

For the purpose of explaining the application of the approach according to the invention it is assumed that a mobile radio subscriber in Germany is currently at an airport and wants to set up an internet connection with his/her UMTS terminal by way of a WLAN radio network based on the IEEE 802.11b technology. His/her terminal possesses a corresponding WLAN module, and on his/her USIM, in the file EF_AWPLMN, as depicted in FIG. 4, there are stored the allowed WLAN networks, and in the file EF_FWPLMN, as depicted in FIG. 5, there are stored the barred WLAN networks.

On his/her USIM, the file EF_AWPLMN contains four entries. According to entry 1, he/she is allowed a WLAN access in Germany in any WLAN network of the type “Public, Type 1” and application “Airport”. According to entry 2, the same also applies to all WLAN networks of the type “Private, Type 1” and application “Hotel, Luxury Category”. According to entry 3, he/she also has a WLAN access in the United Kingdom in any WLAN network of the type “Public, Type 1” and application “Airport”. Finally, according to entry 4, he/she has worldwide access to all WLAN networks of the type “Private, Type 1” and application “Coffee Shops”.

On his/her USIM, the file EF_FWPLMN contains two entries. According to entry 1, in Germany the user is not allowed a WLAN access in any WLAN network of the type “Public, Type 2”, regardless of the application. According to entry 2, the user is not allowed access to a specific WLAN network in the United Kingdom having WNC=017, Type “Public, Type 2” and application “Hotel, Luxury Category”.

According to entry 1 in EF_AWPLMN, a WLAN access in Germany from an airport is allowed, so the mobile radio subscriber can set up an internet connection with his/her UMTS terminal by way of his/her WLAN module.

The invention is not limited to this exemplary embodiment. Rather, it encompasses any implementations possible within the scope of the capabilities of persons skilled in the art which control the essential core of the invention-encoding of identities designating wireless local area networks for the purpose of the unequivocal identification and authentication and implementation of an access to wireless local area networks by UMTS users on the basis of identity lists containing wireless local area networks, which identity lists are stored on the USIM in the UMTS terminal and consequently permit an unequivocal identification and authentication of wireless local area networks for future UMTS users in an uncomplicated manner and also furnish UMTS providers and operators of local area networks with suitable means for controlling the network access in an uncomplicated manner.

1-12. (canceled)

13. A method for operating terminals of a mobile radio communication system, in at least one local wireless network, comprising:
storing at least one item of access information on a terminal, wherein the access information comprises at-least one first item of identification information for the mobile radio communication system and at least one second item of identification information for a local area network,
wherein the second item of identification information comprises a first item of network information indicating the location of the local area network,
and wherein the second item of identification information comprises a second item of network information indicating the type of the local area network, and
wherein the second item of identification information comprises a third item of network information indicating at least one service provided by the local area network.

14. The method according to claim 13, wherein the second item of identification information comprises a fourth item of network information uniquely identifying the local area network.

15. The method according to claim 13, wherein the first, second and/or third items of network information are encoded by means of a maximum of three decimal digits.

16. The method according to claim 14, wherein the fourth item of network information is encoded by means of a maximum of five decimal digits.

17. The method according to claim 13, wherein the second items of identification information are stored as a first list organized in such a way that the first list contains those second items of identification information that are assigned to local area networks which allow the operation of the terminal within the local area network.

18. The method according to claim 14, the second items of identification information are stored as a first list organized in such a way that the first list contains those second items of identification information that are assigned to local area networks which forbid the operation of the terminal within the local area network.

19. The method according to claim 13, wherein the at least first item of access information is stored on a device serving for user identification, in particular a USIM module.
